(19) United States
(12) Patent Application Publication
(10) Pub. No.: US 2026/0213056 A1
(43) Pub. Date: Jul. 23, 2026

(54) DETACHABLE SUPPORTING DEVICE

(71) Applicant: Novium Taiwan Inc., Taipei City (TW)

(72) Inventors: Kuo-Hung Liang, Chiayi City (TW); Ming-Wei Kuo, Taipei City (TW)

(73) Assignee: Novium Taiwan Inc., Taipei City (TW)

(21) Appl. No.: 19/035,781

(22) Filed: Jan. 23, 2025

(51) Int. Cl. H01F 7/02

(52) U.S. Cl. CPC H01F 7/02

(57) ABSTRACT

A detachable supporting device includes a base, a magnetic force providing module and a target component. The base includes a body portion, a first extending portion and a second extending portion. The magnetic force providing module includes three magnetic components. The first magnetic component is disposed on the first extending portion and has two poles respectively facing an upper surface and a lower surface of the body portion. The second magnetic component is disposed on the second extending portion and has two poles respectively facing two lateral surfaces of the body portion. The third magnetic component is disposed on the body portion. The target component includes a main body, a magnetizable unit and a magnetic unit. The magnetizable unit is disposed on the main body to contact a positioning area of the body portion. The magnetic unit is disposed on the main body to function with the two magnetic components.

### BACKGROUND OF THE INVENTION

### 1. Field of the Invention

The present invention relates to a detachable supporting device, and more particularly, to a detachable supporting device of stably holding a target component.

### 2. Description of the Prior Art

A conventional multi-tool, such as a pen-shaped object, a letter opener, a ruler and so on, is generally placed in the storage device, such as the pen holder or the pencil case, and the multi-tool is taken from the pen holder or the pencil case when the user wants to use it. There may be a lot of pens placed in the pen holder, which seems to be messy. There is a pen suspending and supporting device that utilizes the magnetic attraction force to position the pen tip on the base, and further utilizes the magnetic repulsion force to upwardly suspend the pen body, so that the rear section of the pen can be suspended above the base. Therefore, design of a suspending and supporting device applied to the multi-tool can improve aesthetics of the storage device.

### SUMMARY OF THE INVENTION

The present invention provides a detachable supporting device of stably holding a target component for solving above drawbacks.

According to the claimed invention, a detachable supporting device includes a base, a

magnetic force providing module and a target component. The base has a body portion, a first extending portion and a second extending portion. The first extending portion and the second extending portion are extended from the body portion in the same direction. The magnetic force providing module is assembled with the base. The magnetic force providing module includes a first magnetic component, a second magnetic component and a third magnetic component. The first magnetic component is disposed on the first extending portion. Two magnetic poles of the first magnetic component respectively face towards an upper surface and a lower surface of the body portion. The second magnetic component is disposed on the second extending portion. Two magnetic poles of the second magnetic component respectively face towards two lateral surfaces of the body portion. The third magnetic component is disposed on the body portion. The target component is detachably positioned on the base. The target component includes a main body, a magnetizable unit and a magnetic unit. The magnetizable unit is disposed on a front end of the main body to detachably abut against a positioning area of the body portion where on the third magnetic component is disposed. The magnetic unit is disposed on a middle area of the main body to functionalize with the first magnetic component and the second magnetic component.

The detachable supporting device of the present invention can utilize the base to hold the target component; the magnetic force providing module of the base can utilize the third magnetic component to attract the magnetizable unit of the target component, and further utilize the first magnetic component and the second magnetic component to hold the magnetic unit of the target component in a contactless manner, so that the main body of the target component can obliquely stand on the base. The target component can be a multi-tool, such as a letter opener, a ruler and so on, and can be suspended via single-point support; if the target component is a pen-shaped object with a sharp point or any similar external object, the target component can be rotated with its long axis as the rotation axis, and variation of the rotation axis can depend on the shape of the target component and matching of the magnetic component. Each magnetic component of the magnetic force providing module can be preferably hid inside the base, and set on the level the same as or similar to the level where on other magnetic components are disposed; the magnetic component may be optionally exposed out of the base but still located on the same or similar level. The present invention provides several embodiments of relative position between the magnetic unit of the target component and the first magnetic component and the second magnetic component of the magnetic force providing module, and the range of magnetic fields generated by the foresaid embodiments can provide the uniform and stable magnetic repulsion force, so as to stably hold the target component without falling out of the base due to accidental collision or non-contact force.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a detachable supporting device according to a first embodiment of the present invention.

FIG. 2 is a lateral view of the detachable supporting device according to the first embodiment of the present invention.

FIG. 3 is a top view of the detachable supporting device according to different embodiments of the present invention.

FIG. 4 is another top view of the detachable supporting device according to different embodiments of the present invention.

FIG. 5 is a top view of the detachable supporting device according other embodiment of the present invention.

FIG. 6 is another top view of the detachable supporting device according other embodiment of the present invention.

FIG. 7 is a diagram of the detachable supporting device according to a second embodiment of the present invention.

FIG. 8 is a diagram of the detachable supporting device according to a third embodiment of the present invention.

### DETAILED DESCRIPTION

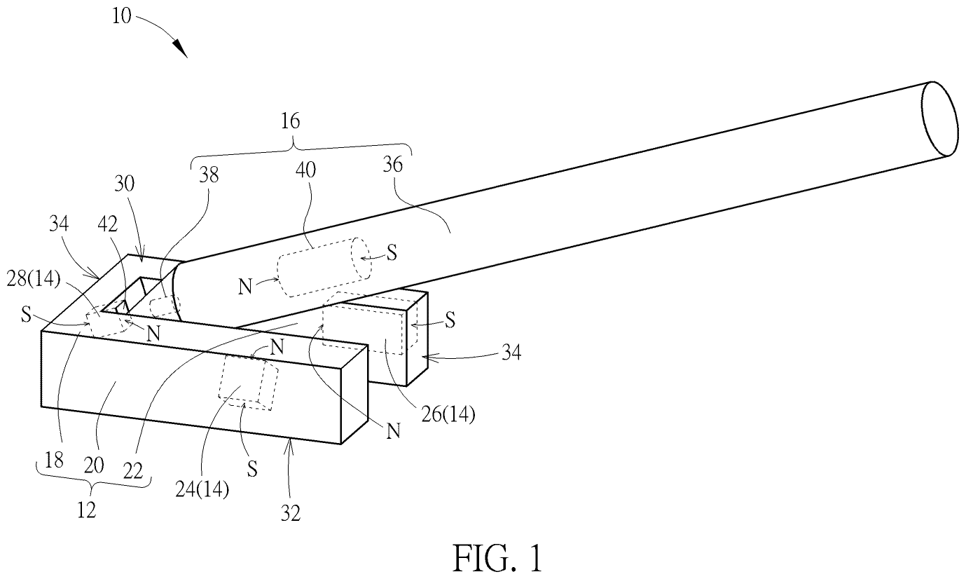

Please refer to FIG. 1. FIG. 1 is a diagram of a detachable supporting device 10 according to a first embodiment of the present invention. The detachable supporting device 10 can include a base 12, a magnetic force providing module 14 and a target component 16. The magnetic force providing module 14 can be assembled with the base 12. The target component 16 can be detachably positioned on the base 12, and present a single-point suspended mode due to the magnetic force of the magnetic force providing module 14. A type of the base 12 is not limited to the embodiment shown in FIG. 1, and can be designed as a pen cap optionally disposed on a rear end (e.g. a right end of the target component 16 shown in FIG. 1) of the target component 16 in a detachable manner, or may be designed as any type that can accommodate the magnetic force providing module 14. Variation of the base 12 can depend on a design demand, and a detailed description of other possible types is omitted herein for simplicity. The base 12 can include a body portion 18, a first extending portion 20 and a second extending portion 22. The first extending portion 20 and the second extending portion 22 can be respectively extended from two opposite sides of the body portion 18 in the same direction, and the first extending portion 20 can be preferably spaced from the second extending portion 22; arrangement of the first extending portion 20 and the second extending portion 22 is not limited to the foresaid embodiment. In addition, arrangement of the first extending portion 20 and the second extending portion 22 relative to the body portion 18 can be symmetrical or asymmetrical, which depends on a design demand.

The magnetic force providing module 14 can include a first magnetic component 24, a second magnetic component 26 and a third magnetic component 28. The first magnetic component 24 can be disposed on the first extending portion 20, and two magnetic poles N and S of the first magnetic component 24 can respectively face towards an upper surface 30 and a lower surface 32 of the body portion 18 and/or the first extending portion 20. The first extending portion 20 can be connected with the body portion 18, and therefore the body portion 18 and the first extending portion 20 can have the common upper surface 30 and the common lower surface 32. The second magnetic component 26 can be disposed on the second extending portion 22, and two magnetic poles N and S of the second magnetic component 26 can respectively face towards two lateral surfaces 34 of the body portion 18 and/or the second extending portion 22. The foresaid two lateral surfaces 34 can be optionally defined as outer surfaces located on a left end and a right end of a combination of the body portion 18 and the second extending portion 22. The third magnetic component 28 can be disposed on the body portion 18. Besides, the first magnetic component 24 and the second magnetic component 26 can be disposed inside the base 12 in a coplanar manner or in a non-coplanar manner.

The target component 16 can be a letter opener, a ruler, a pen-shaped object, or any similar external object. The target component 16 can include a main body 36, a magnetizable unit 38 and a magnetic unit 40. The main body 36 can be a case of the target component 16. The magnetizable unit 38 may be optionally replaced by a magnet. The magnetizable unit 38 can be disposed on a front end of the main body 36, and used to abut against a positioning area 42 of the body portion 18 where on the third magnetic component 28 is disposed. The magnetic unit 40 can be disposed on a middle area of the main body 36, and used to functionalize with the first magnetic component 24 of the first extending portion 20 and the second magnetic component 26 of the second extending portion 22. Position of the magnetic unit 40 on the main body 36 can be changed in accordance with position of the first magnetic component 24 and the second magnetic component 26 on the base 12. Therefore, the target component 16 can present the single-point suspended mode via a magnetic attraction force generated by the magnetizable unit 38 and the third magnetic component 28, and a magnetic repulsion force generated by the magnetic unit 40 and the first magnetic component 24 and the second magnetic component 26.

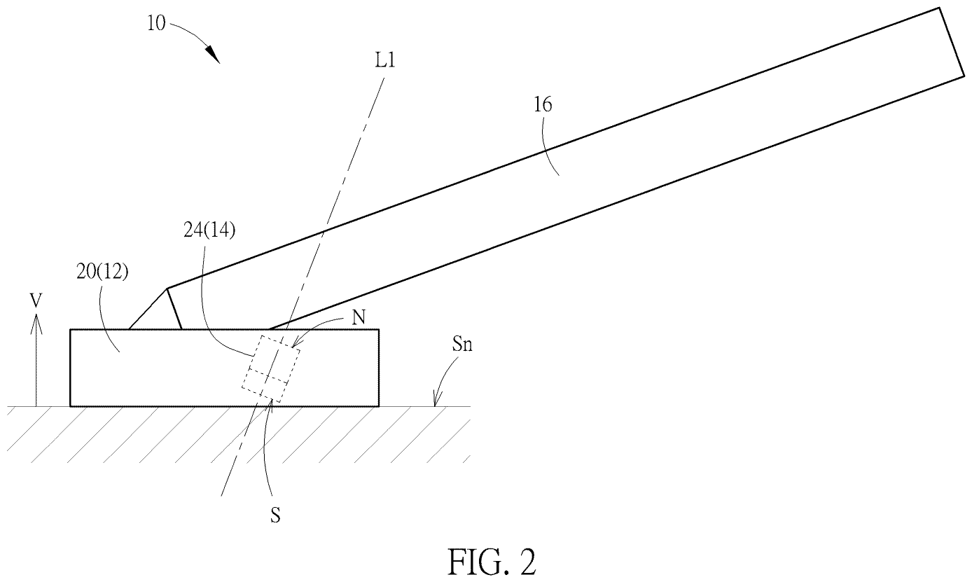

Please refer to FIG. 1 and FIG. 2. FIG. 2 is a lateral view of the detachable supporting device 10 according to the first embodiment of the present invention. The base 12 of the detachable supporting device 10 can be disposed on a supporting plane Sn. An included angle between a connection line L1 of the two magnetic poles N and S of the first magnetic component 24 of the magnetic force providing module 14 and a planar normal vector V of the supporting plane Sn can be preferably ranged between 0~45 degrees. That is to say, the first magnetic component 24 can be disposed inside the first extending portion 20 in a relatively tilted manner. Arrangement of the two magnetic poles N and S of the first magnetic component 24 is not limited to the embodiment shown in the figures, and can be changed in accordance with overall configuration of the detachable supporting device 10, and the detailed description is omitted herein for simplicity. In addition, another connection line (which is not shown in the figures) of the two magnetic poles N and S of the second magnetic component 26 can be substantially perpendicular to the planar normal vector V of the supporting plane Sn, and the practical application of arrangement of the second magnetic component 26 is not limited to the foresaid embodiment; for example, the connection line of the two magnetic poles N and S of the second magnetic component 26 can be substantially parallel to a connection line (which is not shown in the figures) of the two magnetic poles N and S of the magnetic unit 40, or can be located between one position of being perpendicular to the planar normal vector V and another position of being parallel to the connection line of the two magnetic poles N and S of the magnetic unit 40.

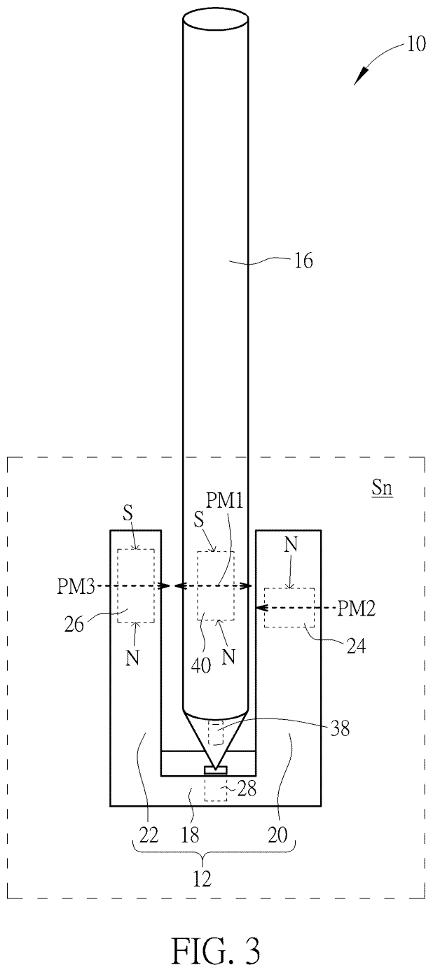

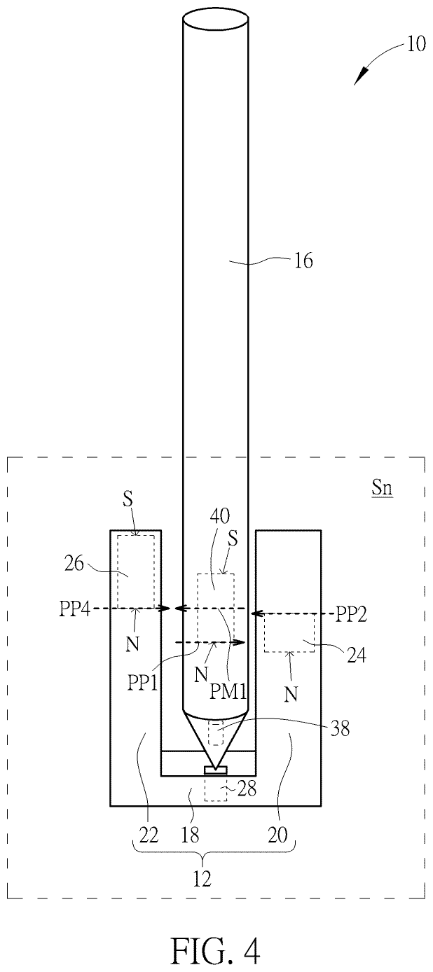

Please refer to FIG. 3 and FIG. 4. FIG. 3 and FIG. 4 are top views of the detachable supporting device 10 according to different embodiments of the present invention. In the preferred embodiment, as shown in FIG. 3, a projection centerline PM1 of the two magnetic poles N and S of the magnetic unit 40 of the target component 16 projected onto the supporting plane Sn can preferably align with a projection centerline PM2 of one magnetic pole (such as the magnetic pole N) of the first magnetic component 24 projected onto the supporting plane Sn. Further, as shown in FIG. 4, a projection boundary PP1 of one magnetic pole (such as the magnetic pole N) of the magnetic unit 40 of the target component 16 projected onto the supporting plane Sn can preferably align with a projection boundary PP2 of an adjacent magnetic pole (such as the magnetic pole N) of the first magnetic component 24 projected onto the supporting plane Sn. Therefore, position relation between the magnetic unit 40 and the first magnetic component 24 can be preferably decided as conforming to position change of the embodiment shown in FIG. 3 and FIG. 4. The magnetic repulsion force generated by the first magnetic component 24 and the magnetic unit 40 can stably support the target component 16 due to the foresaid position relation.

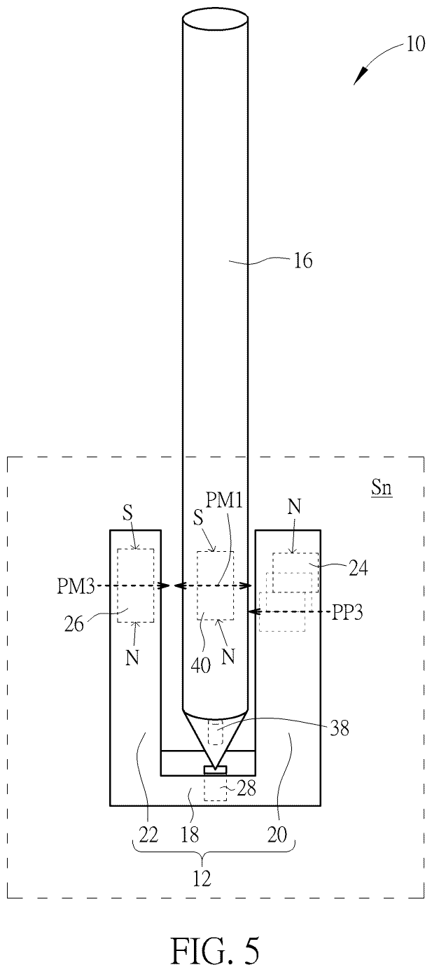

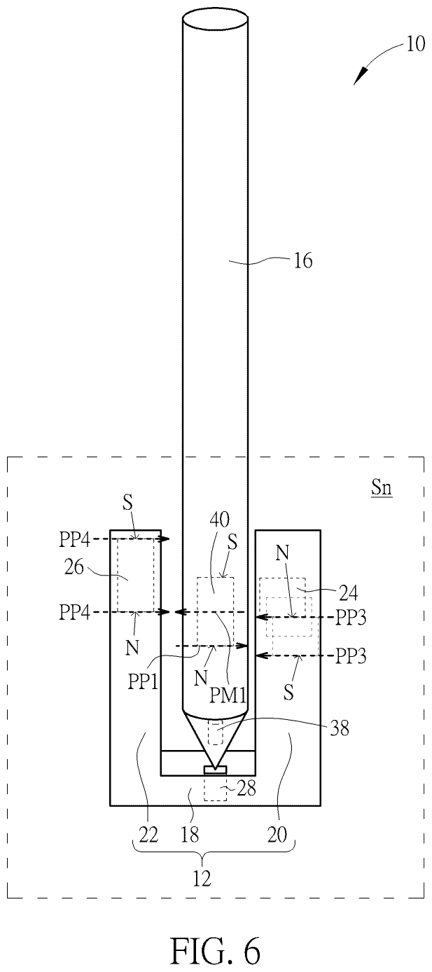

Please refer to FIG. 5 and FIG. 6. FIG. 5 and FIG. 6 are top views of the detachable supporting device 10 according other embodiments of the present invention. As shown in FIG. 5, the projection centerline PM1 of the two magnetic poles N and S of the magnetic unit 40 of the target component 16 projected onto the supporting plane Sn can be preferably located inside a projection boundary PP3 of one magnetic pole (such as the magnetic pole N) of the first magnetic component 24 projected onto the supporting plane Sn. As shown in FIG. 5, two dashed boxes drawn next to the first magnetic component 24 can represent change types of the first magnetic component 24 downwardly moved to other positions (or the first magnetic component 24 is not moved, and the magnetic unit 40 is upwardly moved to present the same position relation). An overlapped region of three positions of the first magnetic component 24 may be defined as a possible projection range; although the first magnetic component 24 is obliquely moved toward the lower left in FIG. 5, the actual application is not limited to this, which is only for a purpose of clearly showing different position changes of the first magnetic component 24 relative to the magnetic unit 40. Therefore, the projection centerline PM1 being located inside the projection boundary PP3 can be interpreted as: a virtual extended segment of the projection centerline PM1 of the magnetic unit 40 can be at least overlapped with the projection range of the projection boundary PP3 of the first magnetic component 24 at any position, so as to conform to the position design requirement of the magnetic unit 40 and the first magnetic component 24 in the present invention.

Or, as shown in FIG. 6, the projection boundary PP1 of one magnetic pole (such as the magnetic pole N) of the magnetic unit 40 of the target component 16 projected onto the supporting plane Sn can located between the upper projection boundary PP3 and the lower projection boundary PP3 of the adjacent magnetic poles N and S of the first magnetic component 24 projected onto the supporting plane Sn, and can preferably align with a middle point between the two projection boundaries PP3. As shown in FIG. 6, two dashed boxes drawn next to the first magnetic component 24 can represent change types of the first magnetic component 24 upwardly or downwardly moved to other positions (or the first magnetic component 24 is not moved, and the magnetic unit 40 is upwardly or downwardly moved to present the same position relation). The overlapped region of three positions of the first magnetic component 24 may be defined as the possible projection range; although the first magnetic component 24 is obliquely moved toward the lower right in FIG. 6, the actual application is not limited to this That is to say, the projection centerline PM1 being located between the projection boundaries PP3 can be interpreted as: a virtual extended segment of the pole boundary (such as the projection boundary PP1) of the magnetic unit 40 can be at least overlapped with the projection range of the projection boundaries PP3 of the first magnetic component 24 at any position.

Please refer to FIG. 3. The projection centerline PM1 of the two magnetic poles N and S of the magnetic unit 40 of the target component 16 projected onto the supporting plane Sn can preferably align with a projection centerline PM3 of the two magnetic poles N and S of the second magnetic component 26 projected onto the supporting plane Sn. Further, please refer to FIG. 6. The projection centerline PM1 of the two magnetic poles N and S of the magnetic unit 40 of the target component 16 projected onto the supporting plane Sn can preferably align with a projection boundary PP4 of an adjacent magnetic pole (such as the magnetic pole N) of the second magnetic component 26 projected onto the supporting plane Sn. Thus, the preferred position of the magnetic unit 40 can be set as: a range of the projection centerline PM1 of the magnetic unit 40 from the projection centerline PM3 to the projection boundary PP4 of the second magnetic component 26, and the projection boundary PP4 can be considered as a projection position (for example, the second magnetic component 26 is laterally arranged, as shown in FIG. 1) of the magnetic pole N or the magnetic pole S of the second magnetic component 26 projected onto the supporting plane Sn, so that the projection centerline PM1 can be preferably located inside the projection range between the two magnetic poles N and S of the second magnetic component 26 projected onto the supporting plane Sn.

According to the foresaid embodiments of the present invention, an allowable placement range of the first magnetic component 24 relative to the magnetic unit 40 can be defined as being between a first arrangement position and a second arrangement position. The first arrangement position of the first magnetic component 24 relative to the magnetic unit 40 can be interpreted as: the projection boundary PP3 on a bottom side of the magnetic pole of the first magnetic component 24 aligns with the projection boundary PP1 on an outer side of the magnetic pole N of the magnetic unit 40. The second arrangement position of the first magnetic component 24 relative to the magnetic unit 40 can be interpreted as: the projection boundary PP2 of a top side of the magnetic pole of the first magnetic component 24 aligns with the projection boundary PP1 on the outer side of the magnetic pole N of the magnetic unit 40.

Accordingly, the allowable placement range of the second magnetic component 26 relative to the magnetic unit 40 can be defined as being between a third arrangement position and a fourth arrangement position. The third arrangement position of the second magnetic component 26 relative to the magnetic unit 40 can be interpreted as: a projection boundary PP4 on an outer side of the magnetic pole S of the second magnetic component 26 aligns with the projection centerline PM1 of the magnetic unit 40. The fourth arrangement position of the second magnetic component 26 relative to the magnetic unit 40 can be interpreted as: the projection boundary PP4 on the outer side of the magnetic pole N of the second magnetic component 26 aligns with the projection centerline PM1 of the magnetic unit 40. In addition, the projection centerline PM1 can preferably align with a middle point between the two projection boundaries PP4.

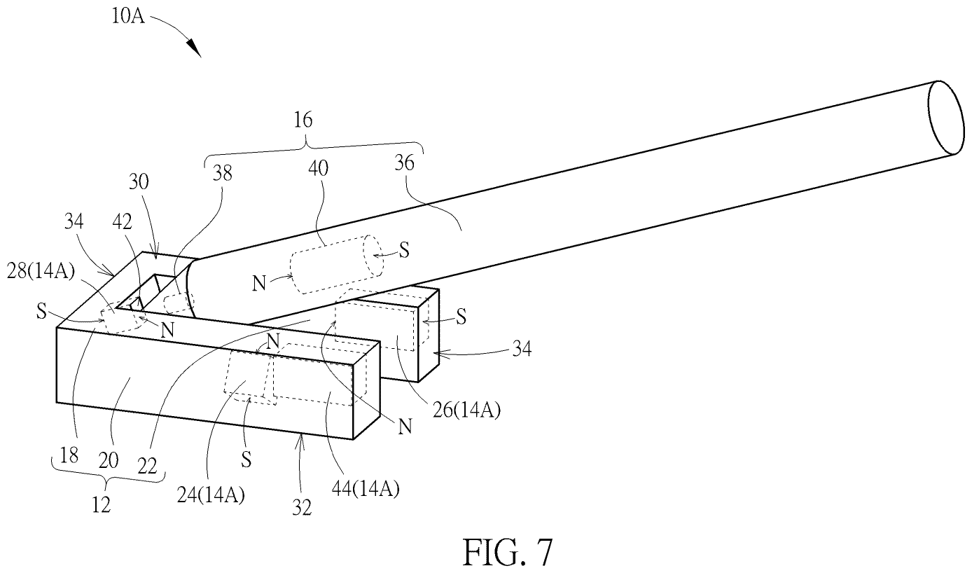

Please refer to FIG. 7. FIG. 7 is a diagram of the detachable supporting device 10A according to a second embodiment of the present invention. In the second embodiment, elements having the same numerals of ones of the first embodiment can have the same structures and functions, and the detailed description is omitted herein for simplicity. The magnetic force providing module 14A of the detachable supporting device 10A can further include a fourth magnetic component 44 disposed on the first extending portion 20. Two magnetic poles of the fourth magnetic component 44 can respectively face towards the two lateral surfaces 34 of the body portion 18, and the first magnetic component 24 can be located between the fourth magnetic component 44 and the third magnetic component 28. Orientation of the two magnetic poles N and S of the fourth magnetic component 44 can be similar to orientation of the two magnetic poles N and S of the second magnetic component 26, and the practical application of the orientation of the magnetic poles is not limited to the foresaid embodiment.

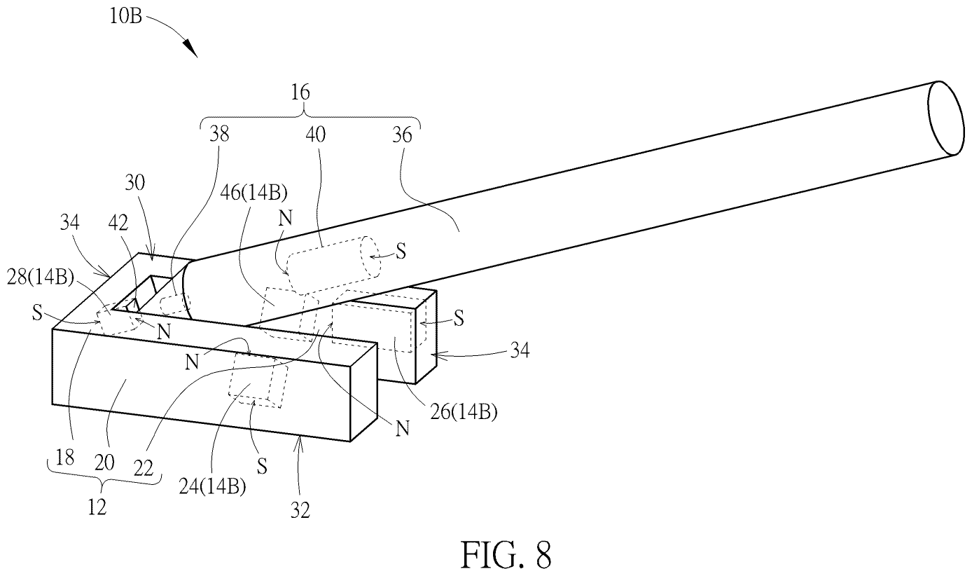

Please refer to FIG. 8. FIG. 8 is a diagram of the detachable supporting device 10B according to a third embodiment of the present invention. In the third embodiment, elements having the same numerals of ones of the foresaid embodiments can have the same structures and functions, and the detailed description is omitted herein for simplicity. The magnetic force providing module 14B of the detachable supporting device 10B can further include a fifth magnetic component 46 disposed on the second extending portion 22. Two magnetic poles N and S of the fifth magnetic component 46 can respectively face towards the upper surface 30 and the lower surface 32 of the body portion 18, and the fifth magnetic component 46 can be located between the second magnetic component 26 and the third magnetic component 28. Orientation of the two magnetic poles N and S of the fifth magnetic component 46 can be similar to orientation of the two magnetic poles N and S of the first magnetic component 24, and the practical application of the orientation of the magnetic poles is not limited to the foresaid embodiment.

In conclusion, the detachable supporting device of the present invention can utilize the base to hold the target component; the magnetic force providing module of the base can utilize the third magnetic component to attract the magnetizable unit of the target component, and further utilize the first magnetic component and the second magnetic component to hold the magnetic unit of the target component in a contactless manner, so that the main body of the target component can obliquely stand on the base. A number, position and magnetic poles of the magnetic component, the magnetizable unit and the magnetic unit are not limited to the foresaid embodiment; any embodiment that provides the magnetic attraction force and/or the magnetic repulsion force to hold the target component can conform to a design scope of the present invention. In addition, the third magnetic component can be the magnet or the component with the magnetizing property, and the magnetizable unit can be iron or the magnet, which depends on the design demand. The target component can be a multi-tool, such as a letter opener, a ruler and so on, and can be suspended via single-point support; if the target component is a pen-shaped object with a sharp point or any similar external object, the target component can be rotated with its long axis as the rotation axis, and variation of the rotation axis can depend on the shape of the target component and matching of the magnetic component. Each magnetic component of the magnetic force providing module can be preferably hid inside the base, and set on the level the same as or similar to the level where on other magnetic components are disposed; the magnetic component may be optionally exposed out of the base but still located on the same or similar level. The present invention provides several embodiments of relative position between the magnetic unit of the target component and the first magnetic component and the second magnetic component of the magnetic force providing module, and the range of magnetic fields generated by the foresaid embodiments can provide the uniform and stable magnetic repulsion force, so as to stably hold the target component without falling out of the base due to accidental collision or non-contact force.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A detachable supporting device comprising:
a base having a body portion, a first extending portion and a second extending portion, the first extending portion and the second extending portion being extended from the body portion in the same direction;
a magnetic force providing module assembled with the base, the magnetic force providing module comprising:
a first magnetic component disposed on the first extending portion, two magnetic poles of the first magnetic component respectively facing towards an upper surface and a lower surface of the body portion;
a second magnetic component disposed on the second extending portion, two magnetic poles of the second magnetic component respectively facing towards two lateral surfaces of the body portion; and
a third magnetic component disposed on the body portion; and
a target component detachably positioned on the base, the target component comprising a main body, a magnetizable unit and a magnetic unit, the magnetizable unit being disposed on a front end of the main body to detachably abut against a positioning area of the body portion where on the third magnetic component is disposed, the magnetic unit being disposed on a middle area of the main body to functionalize with the first magnetic component and the second magnetic component.

2. The detachable supporting device of claim 1, wherein the base is put on a supporting plane, an included angle between a connection line of the two magnetic poles of the first magnetic component and a planar normal vector of the supporting plane is ranged between 0~45 degrees, a connection line of the two magnetic poles of the second magnetic component is located between a position of being perpendicular to the planar normal vector and another position of being parallel to a connection line of two magnetic poles of the magnetic unit.

3. The detachable supporting device of claim 1, wherein the base is put on a supporting plane, a projection centerline of two magnetic poles of the magnetic unit projected onto the supporting plane aligns with a projection centerline of one magnetic pole of the first magnetic component projected onto the supporting plane, or a projection boundary of one magnetic pole of the magnetic unit projected onto the supporting plane is located between two projection boundaries of two adjacent magnetic poles of the first magnetic component projected onto the supporting plane.

4. The detachable supporting device of claim 1, wherein the base is put on a supporting plane, a projection centerline of two magnetic poles of the magnetic unit projected onto the supporting plane is located inside a projection boundary of one magnetic pole of the first magnetic component projected onto the supporting plane, or a projection boundary of one magnetic pole of the magnetic unit projected onto the supporting plane aligns with a projection boundary of an adjacent magnetic pole of the first magnetic component projected onto the supporting plane.

5. The detachable supporting device of claim 1, wherein the base is put on a supporting plane, a projection centerline of two magnetic poles of the magnetic unit projected onto the supporting plane aligns with a projection centerline of two magnetic poles of the second magnetic component projected onto the supporting plane, or the projection centerline of two magnetic poles of the magnetic unit projected onto the supporting plane is located between two projection boundaries of two adjacent magnetic poles of the second magnetic component projected onto the supporting plane.

6. The detachable supporting device of claim 1, wherein the base is put on a supporting plane, a projection centerline of two magnetic poles of the magnetic unit projected onto the supporting plane is located inside a projection boundary of two magnetic poles of the second magnetic component projected onto the supporting plane.

7. The detachable supporting device of claim 1, wherein the first magnetic component and the second magnetic component are disposed inside the base in a coplanar manner or in a non-coplanar manner.

8. The detachable supporting device of claim 1, wherein the detachable supporting device further comprises a fourth magnetic component disposed on the first extending portion, two magnetic poles of the fourth magnetic component respectively face towards the two lateral surfaces of the body portion.

9. The detachable supporting device of claim 8, wherein the first magnetic component is located between the fourth magnetic component and the third magnetic component.

10. The detachable supporting device of claim 1, wherein the detachable supporting device further comprises a fifth magnetic component disposed on the second extending portion, two magnetic poles of the fifth magnetic component respectively face towards the upper surface and the lower surface of the body portion.
